(19) United States
(12) Patent Application Publication
(10) Pub. No.: US 2014/0316659 A1
(43) Pub. Date: Oct. 23, 2014

(54) AIRBAG CONTROL APPARATUS AND METHOD FOR CONTROLLING AIRBAG DEVICE OF VEHICLE

(71) Applicant: HON HAI PRECISION INDUSTRY CO., LTD., New Taipei (TW)

(72) Inventors: HOU-HSIEN LEE, New Taipei (TW); CHANG-JUNG LEE, New Taipei (TW); CHIH-PING LO, New Taipei (TW)

(73) Assignee: HON HAI PRECISION INDUSTRY CO., LTD., New Taipei (TW)

(21) Appl. No.: 14/217,532

(22) Filed: Mar. 18, 2014

(30) Foreign Application Priority Data
Apr. 23, 2013 (TW) 102114486

(51) Int. Cl. B60R 21/015; B60R 21/017; B60R 21/203

(52) U.S. Cl. CPC B60R 21/015; B60R 21/203; B60R 21/017
USPC 701/45

(57) ABSTRACT

In a method for controlling an airbag device of a vehicle, the vehicle includes a steering wheel equipped with a depth-sensing camera, a gyroscope, a drive device, and at least one airbag device. The airbag device includes at least one airbag. The depth-sensing camera captures a 3D scene image of a scene in front of the steering wheel while the vehicle is being driven. The 3D scene image according to a rotation angle of the steering wheel detected by the gyroscope. The 3D scene image is compared with each 3D model of the driver stored in a storage device to determine an actual position of the driver in the 3D scene image to determine whether the driver is in danger. The drive device is driven to unlock the at least one airbag of the airbag device and controls the airbag device to expand the at least one airbag.

### BACKGROUND

1. Technical Field

Embodiments of the present disclosure relate to safety devices for vehicles, and particularly to an airbag control apparatus and a method for controlling an airbag device of a vehicle.

2. Description of Related Art

Airbag devices are examples of safety devices for vehicles. When a vehicle collision occurs, an airbag frontal impact sensor (FIS) of a conventional safety device outputs an airbag expanding signal to expand an airbag of the safety device, so as to protect a driver and passengers of a vehicle. The conventional safety device for the vehicle is problematic in that once an operating signal is applied to an airbag device in response to a vehicle collision, the airbag device is expanded or operated by a predetermined physical parameters, such as a preset pressure or a preset load, to protect the driver and the passengers of the vehicle. However, the conventional safety device is limited by the predetermined physical parameters and may fail to optimally protect the driver and the passengers of the vehicle collision. Therefore, there is room for improvement within the art.

### BRIEF DESCRIPTION OF THE DRAWINGS

FIG. 1 is a block diagram of one embodiment of a vehicle comprising an airbag control apparatus.

FIG. 2 is a schematic diagram illustrating a steering wheel of the vehicle equipped with a depth-sensing camera, a gyroscope, and at least one airbag device.

FIG. 3 is a flowchart of one embodiment of a method for a method for controlling a airbag device of the vehicle using the airbag control apparatus.

FIG. 4 is a schematic diagram illustrating one embodiment of capturing a 3D image of a scene in front of the steering wheel using the depth-sensing camera.

FIG. 5 is a schematic diagram illustrating one embodiment of adjusting a tilting angle of the 3D scene image of the scene according to a rotation angle of the steering wheel.

FIG. 6 is a schematic diagram illustrating one embodiment of marking an image of the driver in the second 3D scene image using a rectangular shape.

FIG. 7 is a schematic diagram illustrating one embodiment of determining whether the driver is in danger while the vehicle is being driven.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a program language. In one embodiment, the program language may be Java, C, or assembly. One or more software instructions in the modules can be embedded in firmware, such as in an EPROM. The modules described herein can be implemented as either software and/or hardware modules and can be stored in any type of non-transitory computer-readable media or storage medium. Some non-limiting examples of a non-transitory computer-readable medium comprise CDs, DVDs, flash memory, and hard disk drives.

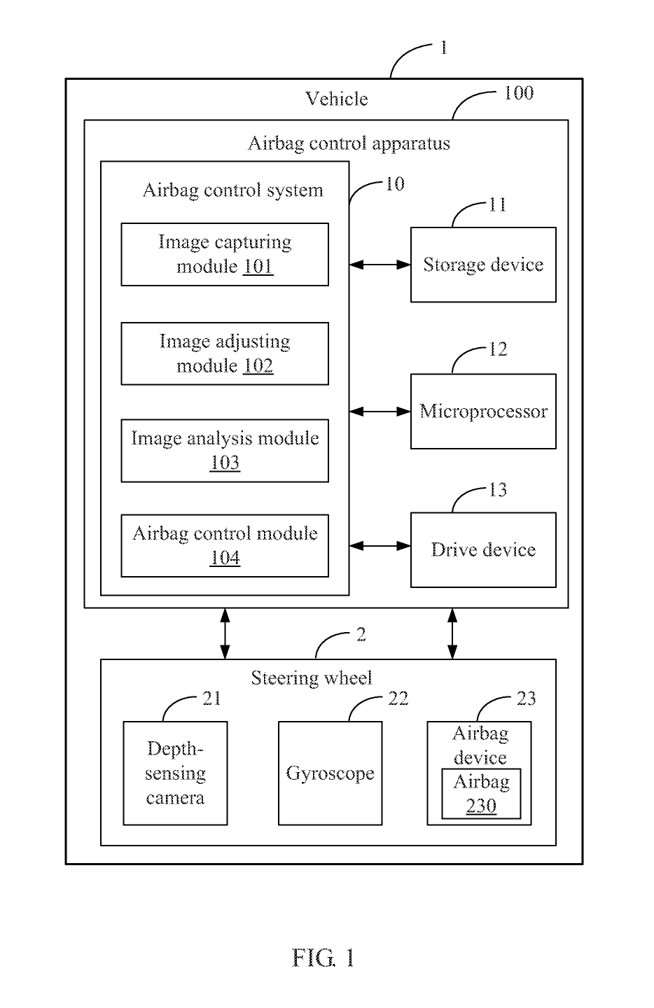

FIG. 1 is a block diagram of one embodiment of a vehicle 1 comprising an airbag control apparatus 100. In the embodiment, the vehicle 1 further includes, but is not limited to, a steering wheel 2. The airbag control apparatus 100 includes an airbag control system 10, a storage device 11, at least one microprocessor 12, and a drive device 13. The air control system 10 comprises computerized instructions in the form of one or more computer-readable programs stored in the storage device 11 and executed by the at least one microprocessor 12. The vehicle 1 can be a car, a bus, a taxi, a truck, or the like. FIG. 1 is only one example of the vehicle 1, other examples may comprise more or fewer components than those shown in the embodiment, or have a different configuration of the various components.

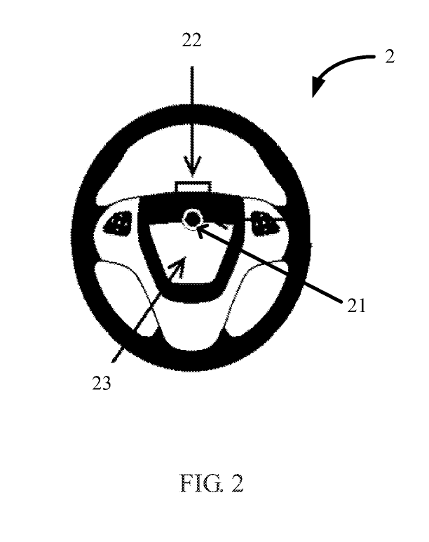

The steering wheel 2 includes a depth-sensing camera 21, a gyroscope 22, and at least one airbag device 23. As show in FIG. 2, the depth-sensing camera 21 is a 3D image capturing device, such as a time of flight (TOF) camera device, which is positioned in the steering wheel 2 to capture 3D images of a scene in front of the steering wheel 2. The gyroscope 22 is embedded in the steering wheel 2, and detects a rotation angle of the steering wheel 2 when a driver of the vehicle 1 turns the steering wheel 2 in a left direction or a right direction. The airbag device 23 includes at least one airbag 230 for charging air to protect the driver of the vehicle 1 when an accident occurs, such as a collision.

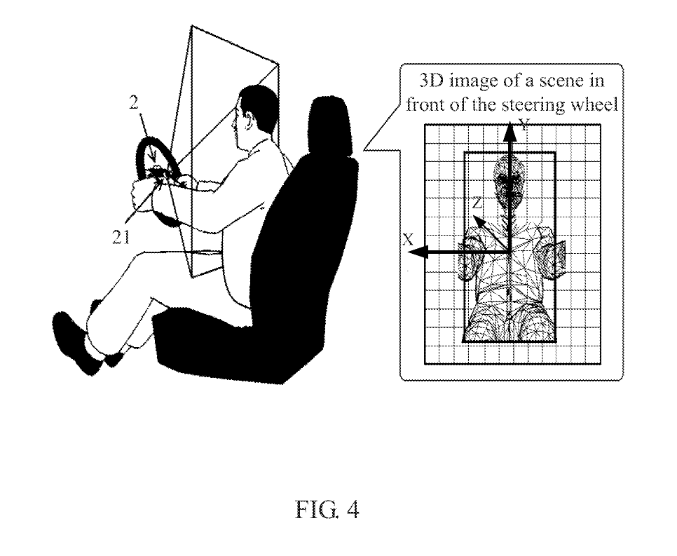

In the embodiment, each of the 3D images may include image data of the scene and a distance between the depth-sensing camera 21 and the driver. Referring to FIG. 4, the depth-sensing camera 21 captures a 3D image of the scene (hereafter “3D scene image”) in front of the steering wheel 2. The 3D scene image can be described as a 3D coordinates system that include X-Y coordinate image data of the scene, and Z-coordinate distance data of the driver. In the embodiment, the X-coordinate value represents a width of the scene, such as 100 cm. The Y-coordinate value represents a height of the scene, such as 160 cm. The Z-coordinate distance data represents a distance between the depth-sensing camera 21 and the driver, which can be calculated by analyzing the 3D scene image.

In one embodiment, the storage device 11 can be an internal storage system, such as a flash memory, a random access memory (RAM) for temporary storage of information, and/or a read-only memory (ROM) for permanent storage of information. The storage device 11 can also be an external storage system, such as an external hard disk, a storage card, or a data storage medium. The at least one microprocessor 12 can be a central processing unit (CPU), a data processor, or other data processor chip that performs various functions of the airbag control apparatus 100 included in the vehicle 1. The drive device 13 can be a drive motor that drives the airbag device 23 to unlock the at least one airbag 230, and controls the airbag device 23 to expand the at least one airbag 230 by deploying automatically.

In the embodiment, the air control system 10 comprises an image capturing module 101, an image adjusting module 102, an image analysis module 103, and an airbag control module 104. The modules 101-104 can comprise computerized instructions in the form of one or more computer-readable programs that are stored in a non-transitory computer-readable medium (such as the storage device 11) and executed by the at least one microprocessor 12 of the airbag control apparatus 100. A description of each module is given in the following paragraphs.

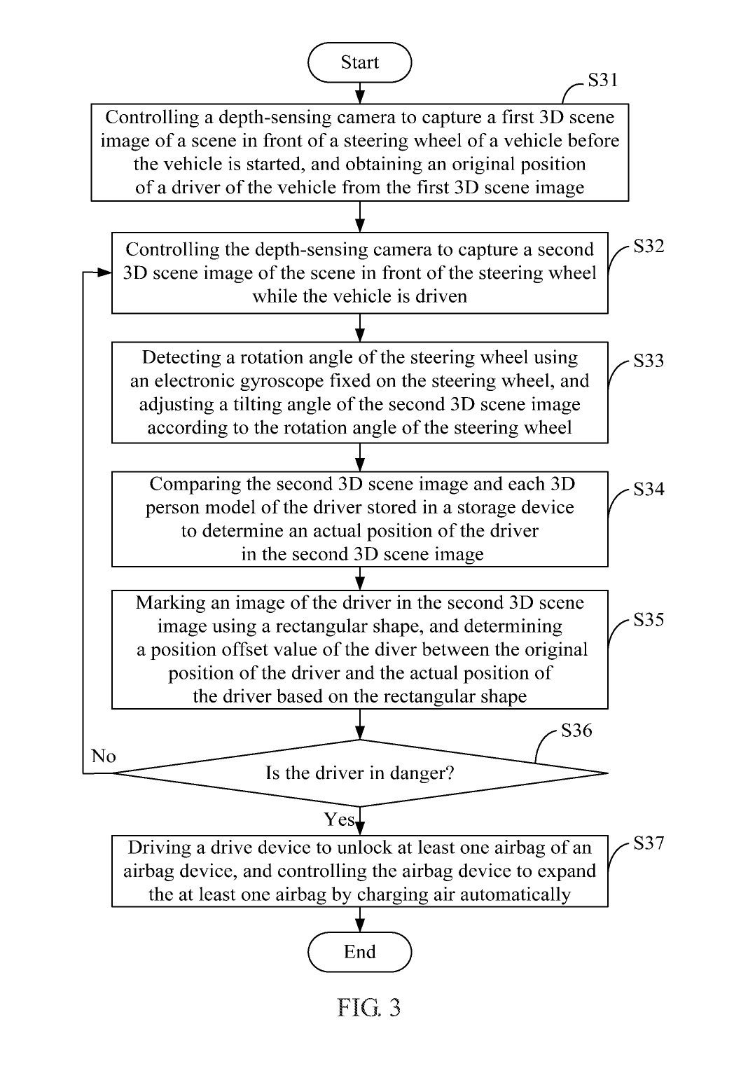

FIG. 3 is a flowchart of one embodiment of a method for controlling the airbag device 23 of the vehicle 1 using the airbag control apparatus 100. In one embodiment, the method is performed by execution of computer-readable software program codes or instructions by the at least one microprocessor 12 of the airbag control apparatus 100. By implementing the method, the airbag control apparatus 100 controls the airbag device 23 to expand the at least one airbag 230 to protect the driver of the vehicle 1 from injury when an accident occurs. Depending on the embodiment, additional steps can be added, other steps can be removed, and the ordering of the steps can be changed.

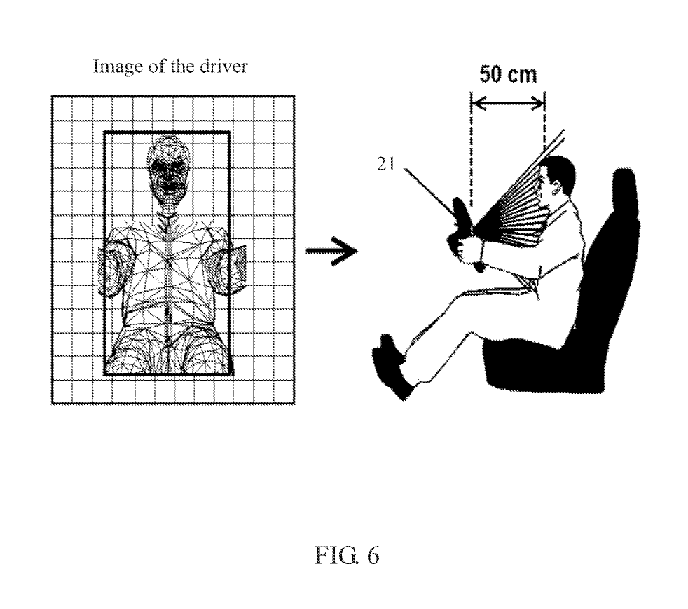

In step S31, the image capturing module 101 controls the depth-sensing camera 21 to capture a first 3D scene image of a scene in front of the steering wheel 2 of the vehicle 1 before the vehicle 1 is started and the driver is sitting in the driver's seat, and obtains an original position of the driver from the first 3D scene image. The image capturing module 101 further stores the first 3D scene image and the original position of the driver into the storage device 11. In the embodiment, the first 3D scene image include X-Y coordinate image data of the scene, and a Z-coordinate distance between the depth-sensing camera 21 and the driver, such as 50 cm shown in FIG. 6.

In step S32, the image capturing module 101 controls the depth-sensing camera 21 to capture a second 3D scene image of the scene in front of the steering wheel 2 while the vehicle 1 is being driven. Referring to FIG. 4, the depth-sensing camera 21 captures the second 3D scene image of the scene in front of the steering wheel 2 while the vehicle is being driven. The second 3D scene image also includes X-Y coordinate image data of the scene, and a Z-coordinate distance between the depth-sensing camera 21 and the driver.

In step S33, the image adjusting module 102 detects a rotation angle of the steering wheel 2 using the gyroscope 22 fixed on the steering wheel 2, and adjusts a tilting angle of the second 3D scene image according to the rotation angle of the steering wheel 2. The depth-sensing camera 21 may tilt from a horizontal level when the vehicle 1 is driven along a route, so that the depth-sensing camera 21 may capture the second 3D scene image having the tilting angle which distorts an actual 3D scene image of the scene in front of the steering wheel 2.

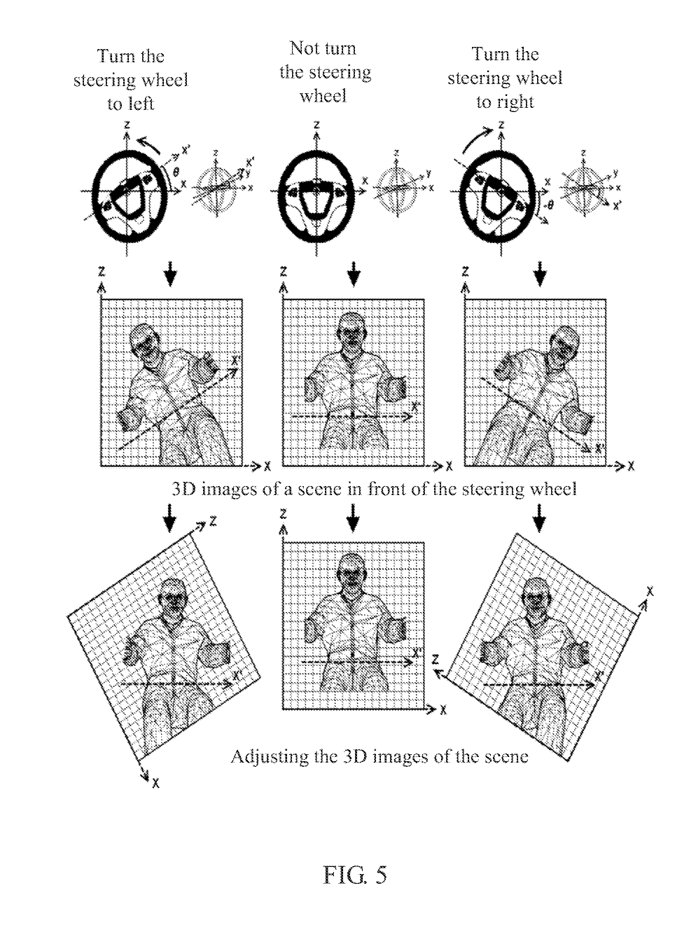

FIG. 5 is a schematic diagram illustrating one embodiment of adjusting a tilting angle of the second 3D scene image according to the rotation angle of the steering wheel 2. In the embodiment, if the driver turns the steering wheel 2 left with a rotation angle “θ”, the image adjusting module 102 adjusts the tilting angle of the second 3D scene image to the rotation angle “θ” in a left direction. If the driver turns the steering wheel 2 right with the rotation angle “θ”, the image adjusting module 102 adjusts the tilting angle of the second 3D scene image to the rotation angle “θ” in a right direction.

In step S34, the image analysis module 103 compares the second 3D scene image and each 3D model of the driver stored in the storage device 11 to determine an actual position of the driver in the second 3D scene image. In the embodiment, the 3D model of the driver is created by performing the following steps: (a) using the depth-sensing camera 21 to capture 3D images of the driver, and obtaining a distance between the depth-sensing camera 21 and the driver from each 3D image of the driver; (b) storing all the distances into a character array; (c) ranking all the distances in the character array according to an ascending order; (d) calculating a position tolerance range of the driver according to the ranked distances; and (e) creating the 3D models of the driver according to the position tolerance range of the driver, and storing the 3D models of the driver into the storage device 11.

In the embodiment, the image analysis module 103 determines an actual position of the driver in the second 3D scene image by performing the following steps: (a) obtaining a distance between the depth-sensing camera 21 and each point of the second 3D scene image, and storing all the distances into a scene array; (b) ranking all the distances in the scene array according to an ascending order, and calculating a pixel difference between each pixel value of the second 3D scene image and each pixel value of the 3D model; (c) determining that a pixel value of the second 3D scene image is within the position tolerance range of the driver if the pixel difference between the pixel value of the second 3D scene image and a corresponding pixel value of the 3D model is less than 5%; and (d) determining an area of the second 3D scene image as the actual position of the driver if more than 80% of pixel values of the second 3D scene image are within the position tolerance range of the driver.

In step S35, the image analysis module 103 marks an image of the driver in the second 3D scene image using a rectangular shape, and determines a position offset value of the diver between the original position of the driver and the actual position of the driver based on the rectangular shape. Referring to FIG. 6, the image of the driver in the second 3D scene image is marked using the rectangular shape, and the position offset value of the diver is determined based on the rectangular shape.

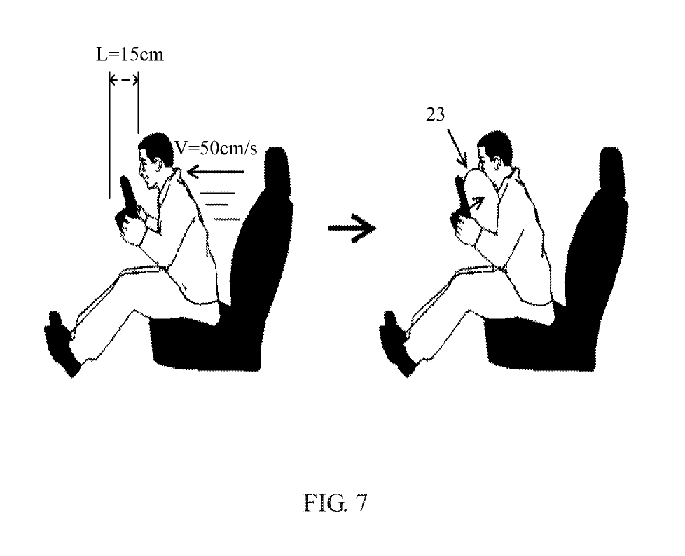

In step S36, the image analysis module 103 determines whether the driver is in danger (i.e., the at least one airbag 230 needs to be expanded) according to the position offset value. Referring to FIG. 7, if the position offset value of the diver is less than a predefined safety distance such as 15 cm, the image analysis module 103 determines that the driver is in danger while the vehicle 1 is driven, and the at least one airbag 230 needs to be expanded to protect the driver from damage injury. The safety distance can be preset by the driver according to a speed of the vehicle 1. For example, the driver may set 15 cm as a safety distance between the steering wheel 2 and the driver when the speed of the vehicle 1 is 50 cm/s. If the driver is in danger, step S37 is implemented. Otherwise, if the driver is not in danger, the process goes back to step S32.

In step S37, the airbag control module 104 drives the drive device 13 to unlock the at least one airbag 230 of the airbag device 23, and controls the airbag device 23 to expand the at least one airbag 230 automatically. As such, the airbag device 23 is controlled to automatically expand the at least one airbag 230 before an accident occurs in the vehicle 1, such as, so as to protect the driver of the vehicle 1 from damage injury.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. An airbag control apparatus for a vehicle, the vehicle comprising a steering wheel equipped with an airbag device comprising at least one airbag, the airbag control apparatus comprising:
a drive device, and at least one microprocessor; and
a storage device storing a computer-readable program comprising instructions that, which when executed by the at least one microprocessor, cause the at least one microprocessor to:
control a depth-sensing camera to capture a first 3D scene image of a scene in front of the steering wheel before the vehicle is started, and obtain an original position of a driver of the vehicle from the first 3D scene image;
control the depth-sensing camera to capture a second 3D scene image of the scene in front of the steering wheel while the vehicle is being driven;
detect a rotation angle of the steering wheel using a gyroscope, and adjust a tilting angle of the second 3D scene image according to the rotation angle of the steering wheel;
compare the second 3D scene image and each 3D model of the driver stored in the storage device to determine an actual position of the driver in the second 3D scene image;
calculate a position offset value between the original position of the driver and the actual position of the driver;
determine whether the at least one airbag needs to be expanded according to the position offset value; and
drive the drive device to unlock the at least one airbag, and control the airbag device to expand the at least one airbag.

2. The airbag control apparatus according to claim 1, wherein the depth-sensing camera is a 3D image capturing device that is positioned in the steering wheel to capture 3D images of the scene in front of the steering wheel, and each of the 3D images of the scene comprises X-Y coordinate image data of the scene, and a Z-coordinate distance between the depth-sensing camera and the driver of the vehicle.

3. The airbag control apparatus according to claim 1, wherein the gyroscope is embedded in the steering wheel, and detects the rotation angle of the steering wheel when the driver of the vehicle turns the steering wheel in a left direction or a right direction.

4. The airbag control apparatus according to claim 1, wherein the computer-readable program further causes the microprocessor to mark an image of the driver in the second 3D scene image using a rectangular shape, and calculate the position offset value between the original position of the driver and the actual position of the driver based on the rectangular shape.

5. The airbag control apparatus according to claim 1, wherein the 3D model of the driver is created by performing the following steps:
using the depth-sensing camera to capture 3D images of the driver, and obtaining a distance between the depth-sensing camera and the driver from each of the 3D images;
storing all the distance into a character array;
ranking all the distance in the character array according to an ascending order;
calculating a position tolerance range of the driver according to the ranked distance; and
creating the 3D model of the driver according to the position tolerance range of the driver, and storing the 3D model of the driver into the storage device.

6. The airbag control apparatus according to claim 1, wherein the actual position of the driver in the second 3D scene image is determined by performing the following steps:
obtaining a distance between the depth-sensing camera and each point of the second 3D scene image, and storing all distances into a scene array;
ranking the distances in the scene array according to an ascending order, and calculating a pixel difference between each pixel value of the second 3D scene image and each pixel value of the 3D model;
determining that a pixel value of the second 3D scene image is within a position tolerance range of the driver if the pixel difference between the pixel value of the second 3D scene image and a corresponding pixel value of the 3D model is less than 5%; and
determining an area of the second 3D scene image as the actual position of the driver if more than 80% of pixel values of the points of the second 3D scene image are within the position tolerance range of the driver.

7. A method for controlling an airbag device of a vehicle using an airbag control apparatus, the airbag device comprising at least one airbag, the airbag control apparatus comprising a drive device, the method comprising steps of:
controlling a depth-sensing camera to capture a first 3D scene image of a scene in front of the steering wheel before the vehicle is started, and obtaining an original position of a driver of the vehicle from the first 3D scene image;
controlling the depth-sensing camera to capture a second 3D scene image of the scene in front of the steering wheel while the vehicle is being driven;
detecting a rotation angle of the steering wheel using a gyroscope, and adjusting a tilting angle of the second 3D scene image according to the rotation angle of the steering wheel;
comparing the second 3D scene image and each 3D model of the driver stored in the storage device to determine an actual position of the driver in the second 3D scene image;
calculating a position offset value between the original position of the driver and the actual position of the driver;
determining whether the at least one airbag needs to be expanded according to the position offset value; and
driving the drive device to unlock the at least one airbag, and controlling the airbag device to expand the at least one airbag.

8. The method according to claim 7, wherein the depth-sensing camera is a 3D image capturing device that is positioned in the steering wheel to capture 3D images of the scene in front of the steering wheel, and each of the 3D images of the scene comprises X-Y coordinate image data of the scene, and a Z-coordinate distance between the depth-sensing camera and the driver of the vehicle.

9. The method according to claim 7, wherein the gyroscope is embedded in the steering wheel, and detects the rotation angle of the steering wheel when the driver of the vehicle turns the steering wheel in a left direction or a right direction.

10. The method according to claim 7, further comprising:
marking an image of the driver in the second 3D scene image using a rectangular shape; and
calculating the position offset value between the original position of the driver and the actual position of the driver based on the rectangular shape.

11. The method according to claim 7, wherein the 3D model of the driver is created by performing the following steps:
using the depth-sensing camera to capture 3D images of the driver, and obtaining a distance between the depth-sensing camera and the driver from each of the 3D images;
storing all the distance into a character array;
ranking all the distance in the character array according to an ascending order;
calculating a position tolerance range of the driver according to the ranked distance; and
creating the 3D model of the driver according to the position tolerance range of the driver, and storing the 3D model of the driver into the storage device.

12. The method according to claim 7, wherein the actual position of the driver in the second 3D scene image is determined by performing the following steps:
obtaining a distance between the depth-sensing camera and each point of the second 3D scene image, and storing all distances into a scene array;
ranking the distances in the scene array according to an ascending order, and calculating a pixel difference between each pixel value of the second 3D scene image and each pixel value of the 3D model;
determining that a pixel value of the second 3D scene image is within a position tolerance range of the driver if the pixel difference between the pixel value of the second 3D scene image and a corresponding pixel value of the 3D model is less than 5%; and
determining an area of the second 3D scene image as the actual position of the driver if more than 80% of pixel values of the points of the second 3D scene image are within the position tolerance range of the driver.

13. A non-transitory storage medium having instructions, when executed by at least one microprocessor of an airbag control apparatus, stored thereon that cause the microprocessor to perform a method for controlling an airbag device of a vehicle, the airbag device comprising at least one airbag, the airbag control apparatus comprising a drive device, the method comprising:
controlling a depth-sensing camera to capture a first 3D scene image of a scene in front of the steering wheel before the vehicle is started, and obtaining an original position of a driver of the vehicle from the first 3D scene image;
controlling the depth-sensing camera to capture a second 3D scene image of the scene in front of the steering wheel while the vehicle is being driven;
detecting a rotation angle of the steering wheel using a gyroscope, and adjusting a tilting angle of the second 3D scene image according to the rotation angle of the steering wheel;
comparing the second 3D scene image and each 3D model of the driver stored in the storage device to determine an actual position of the driver in the second 3D scene image;
calculating a position offset value between the original position of the driver and the actual position of the driver;
determining whether the at least one airbag needs to be expanded according to the position offset value; and
driving the drive device to unlock the at least one airbag, and controlling the airbag device to expand the at least one airbag.

14. The storage medium according to claim 13, wherein the depth-sensing camera is a 3D image capturing device that is positioned in the steering wheel to capture 3D images of the scene in front of the steering wheel, and each of the 3D images of the scene comprises X-Y coordinate image data of the scene, and a Z-coordinate distance between the depth-sensing camera and the driver of the vehicle.

15. The storage medium according to claim 13, wherein the gyroscope is embedded in the steering wheel, and detects the rotation angle of the steering wheel when the driver of the vehicle turns the steering wheel in a left direction or a right direction.

16. The storage medium according to claim 13, wherein the method further comprises:
marking an image of the driver in the second 3D scene image using a rectangular shape; and
calculating the position offset value between the original position of the driver and the actual position of the driver based on the rectangular shape.

17. The storage medium according to claim 13, wherein the 3D model of the driver is created by performing the following steps:
using the depth-sensing camera to capture 3D images of the driver, and obtaining a distance between the depth-sensing camera and the driver from each of the 3D images;
storing all the distance into a character array;
ranking all the distance in the character array according to an ascending order;
calculating a position tolerance range of the driver according to the ranked distance; and
creating the 3D model of the driver according to the position tolerance range of the driver, and storing the 3D model of the driver into the storage device.

18. The storage medium according to claim 13, wherein the actual position of the driver in the second 3D scene image is determined by performing the following steps:
obtaining a distance between the depth-sensing camera and each point of the second 3D scene image, and storing all distances into a scene array;
ranking the distances in the scene array according to an ascending order, and calculating a pixel difference between each pixel value of the second 3D scene image and each pixel value of the 3D model;
determining that a pixel value of the second 3D scene image is within a position tolerance range of the driver if the pixel difference between the pixel value of the second 3D scene image and a corresponding pixel value of the 3D model is less than 5%; and
determining an area of the second 3D scene image as the actual position of the driver if more than 80% of pixel values of the points of the second 3D scene image are within the position tolerance range of the driver.
